(19) United States
(12) Patent Application Publication
(10) Pub. No.: US 2025/0050491 A1
(43) Pub. Date: Feb. 13, 2025

(54) Power Tool with Light Array

(71) Applicant: Milwaukee Electric Tool Corporation, Brookfield, WI (US)

(72) Inventors: Mark W. Kelly, Wauwatosa, WI (US); Gabriela Mysliwiec, Milwaukee, WI (US); Nicholas C. Cera, Muskego, WI (US); Alexandria D. Gaass, Denver, CO (US); Thomas M. Tobolski, Oak Creek, WI (US); Nicholas M. Monica, Milwaukee, WI (US)

(21) Appl. No.: 18/773,886

(22) Filed: Jul. 16, 2024

Related U.S. Application Data
(60) Provisional application No. 63/518,777, filed on Aug. 10, 2023.

(51) Int. Cl. B25F 5/02; F21V 23/00; F21V 33/00

(52) U.S. Cl. CPC B25F 5/02; F21V 23/003; F21V 33/0084

(57) ABSTRACT

A power tool including a housing, a motor, a trigger assembly including a trigger, a light array, and an electronic controller. The electronic controller is configured to detect actuation of the trigger; in response to detecting actuation of the trigger, control the motor to perform a tool operation according to a first mode of a plurality of tool modes of the power tool and control the light array to output a first color light indicative of the first mode for a duration of the tool operation; detect de-actuation of the trigger; and in response to detecting de-actuation of the trigger, control the light array to output a second color light that is different from the first color light and indicative of whether the tool operation was successful.

### CROSS-REFERENCE TO RELATED APPLICATIONS

This application claims priority to U.S. Provisional Application No. 63/518,777, filed on Aug. 10, 2023, titled “POWER TOOL WITH LIGHT ARRAY,” which is hereby incorporated by reference in its entirety.

### STATEMENT REGARDING FEDERALLY SPONSORED RESEARCH

N/A

### BACKGROUND

Power tools can be used for a variety of purposes such as, for example, cutting, drilling, driving, sanding, shaping, grinding, polishing, painting, heating, lighting, cleaning, gardening, and construction, among other uses. Individual power tools can be configured to perform a variety of complex tasks that may benefit from proper tool calibration and/or effective means for indicating operational status and other parameters to the operator of the tool.

### SUMMARY

Some embodiments of the disclosure provide a power tool. The power tool includes a housing; a motor supported by the housing; a trigger assembly supported by the housing and including a trigger that is configured to be actuated; a light array supported by the housing and including a plurality of illuminating elements configured to output light in a plurality of colors; and an electronic controller including a processor and a memory and coupled to the motor, the trigger assembly, and the light array. The electronic controller is configured to detect actuation of the trigger; in response to detecting actuation of the trigger, control the motor to perform a tool operation according to a first mode of a plurality of tool modes of the power tool and control the light array to output a first color light indicative of the first mode for a duration of the tool operation; detect de-actuation of the trigger; and in response to detecting de-actuation of the trigger, control the light array to output a second color light that is different from the first color light and indicative of whether the tool operation was successful.

Some embodiments of the disclosure provide a method performed by a power tool. The method includes detecting actuator of a trigger of the power tool; in response to detecting actuation of the trigger, control a motor of the power tool to perform a tool operation according to a first mode of a plurality of tool modes of the power tool and control a light array of the power tool to output a first color light indicative of the first mode for a duration of the tool operation; detecting de-actuation of the trigger of the power tool; and controlling the light array of the power tool to output a second color light that is different than the first color light and indicative of whether the tool operation was successful.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is an illustration of different components in an example wireless power tool system, in accordance with some embodiments.

FIG. 2 is a block diagram illustrating different components of an example power tool that can be used in the system of FIG. 1, in accordance with some embodiments.

FIG. 3 is a block diagram illustrating different components of an example wireless communication device that can be used in the system of FIG. 1, in accordance with some embodiments.

FIGS. 4A-4B show perspective views of the example power tool of FIG. 2 including a light array, in accordance with some embodiments.

FIGS. 5A-5B show perspective views of different example implementations of a mode selector on power tools in the system of FIG. 1, in accordance with some embodiments.

FIG. 6 shows a perspective view of the example wireless communication device of FIG. 3 and an associated example user interface along with the example power tool of FIG. 2 including the example light array of FIGS. 4A-4B, in accordance with some embodiments.

FIG. 7 shows further examples of the user interface of FIG. 6 presented on the example wireless communication device of FIG. 3, in accordance with some embodiments.

FIG. 8 shows a diagram illustrating example functionality of the example light array of FIGS. 4A-4B with respect to user error alerts, in accordance with some embodiments.

FIG. 9 shows a diagram illustrating example functionality of the example light array of FIGS. 4A-4B with respect to go to app alerts, in accordance with some embodiments.

FIG. 10 shows a diagram illustrating example functionality of the example light array of FIGS. 4A-4B with respect to battery error alerts, in accordance with some embodiments.

FIG. 11 shows a diagram illustrating example functionality of the example light array of FIGS. 4A-4B with respect to service center alerts, in accordance with some embodiments.

FIG. 12 shows a diagram illustrating example functionality of the example light array of FIGS. 4A-4B with respect to bolt joint numbering sequences, in accordance with some embodiments.

FIGS. 13A-13C show a first example table detailing example blink patterns that can be implemented by the example light array of FIGS. 4A-4B, in accordance with some embodiments.

FIGS. 14A-14F show a second example table detailing further example blink patterns that can be implemented by the example light array of FIGS. 4A-4B, in accordance with some embodiments.

FIG. 15 shows a flowchart illustrating an example process for operating the example power tool of FIG. 2 and the example light array of FIGS. 4A-4B during operations of the example power tool of FIG. 2, in accordance with some embodiments.

### DETAILED DESCRIPTION

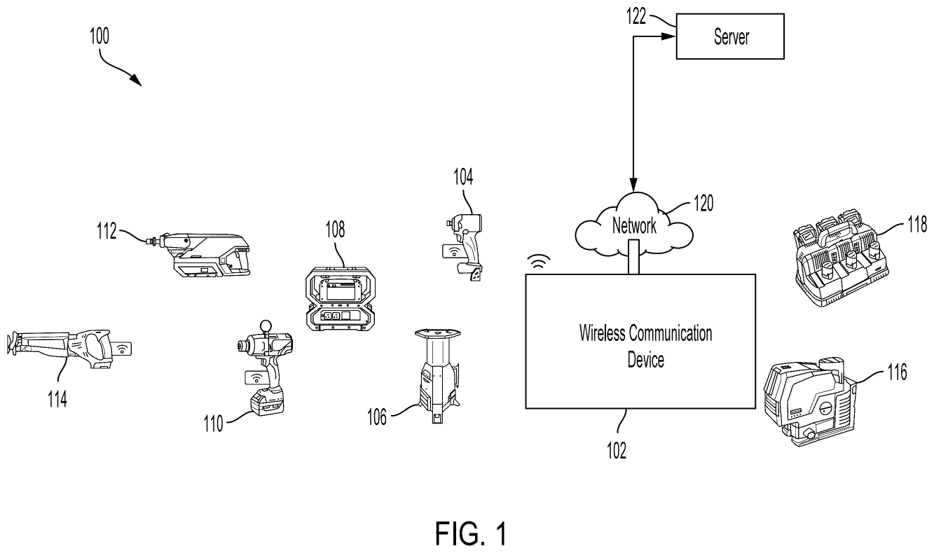

FIG. 1 illustrates an example wireless power tool system 100. Power tool system 100 includes a wireless communication device 102 and a collection of power tools including a power tool 104, a power tool 106, a power tool 108, a power tool 110, a power tool 112, a power tool 114, a power tool 116, and a power tool 118. In power tool system 100, the wireless communication device 102 and power tools 104, 106, 108, 110, 112, 114, 116, and 118 are connected to a wireless network 120 and a server 122. Wireless communication device 102 can be configured to communicate directly and indirectly with each of power tools 104, 106, 108, 110, 112, 114, 116, and 118. For example, wireless communication device 102 can be configured to control various operating parameters associated with each of power tools 104, 106, 108, 110, 112, 114, 116, and 118. Wireless communication device 102 can also be used to view, via a user interface presented on wireless communication device 102, a variety of different data and information about each of power tools 104, 106, 108, 110, 112, 114, 116, and 118. Wireless communication device 102 can also be used to configure settings for wireless network 120, such as, for example, adding or removing power tools from wireless network 120.

Wireless communication device 102, also referred to as a user device, can be implemented in a variety of different ways. For example, wireless communication device 102 can include components such as, for example, a processor, memory, a display, inputs (e.g., a keyboard, a mouse, a graphical user interface, a touch-screen display, one or more actuatable buttons, etc.), communication devices (e.g., an antenna and appropriate corresponding circuitry), etc. Wireless communication device 102 can also simply be implemented as a processor with a communication interface. Wireless communication device 102 can be implemented as a mobile phone (e.g., a smart phone), a personal digital assistant (“PDA”), a laptop, a notebook, a netbook computer, a tablet computing device, and other similar types of wireless electronic devices. Wireless communication device 102 can include a power source (e.g., an AC power source, a DC power source, etc.), which can be in electrical communication with one or more power outlets (e.g., AC or DC outlets) and/or one or more charging ports (e.g., for charging a battery pack of a power tool).

Thus, in some cases, wireless communication device 102 can be a portable power supply and/or a charging device for one or more of power tools 104, 106, 108, 110, 112, 114, 116, and 118. Wireless communication device 102 can also be implemented as a cellular tower, a Wi-Fi router, a network switch, and other types of networking devices. In this way, some (or all) of power tools 104, 106, 108, 110, 112, 114, 116, and 118 can be configured to communicate with wireless communication device 102 implemented as a cell tower (e.g., a power tool can have antennas, transmitters, transceivers, cellular modules, etc., that facilitate communication with the cellular tower so that a power tool can communicate therewith), and thus power tools that are not able to directly communicate (e.g., lack the electronic circuitry including an antenna, a transmitter, a transceiver, etc.) with the wireless communication device 102 (e.g., implemented as a cellular tower) can still indirectly communicate, via wireless network 120, via other power tools that are configured to communicate directly with the wireless communication device 102. Regardless of the configuration of wireless network 120, wireless communication device 102 can receive an identifier for each of power tools 104, 106, 108, 110, 112, 114, 116, and 118.

Each of power tools 104, 106, 108, 110, 112, 114, 116, and 118 can include an actuator, a power source (e.g., a battery pack), an electronic controller, a power source interface (e.g., a battery pack interface), and/or other similar components. Power tools 104, 106, 108, 110, 112, 114, 116, and 118 can be different kinds of power tools, or they can all be the same types of power tools. For example, one or more of power tools 104, 106, 108, 110, 112, 114, 116, and 118 can be an impact driver, a power drill, a hammer drill, a pipe cutter, a sander, a nailer, a grease gun, a crimper, a battery charger, or any other suitable tool. Power tools 104, 106, 108, 110, 112, 114, 116, and 118 can be used for various purposed such as, for example, cutting, drilling, driving, sanding, shaping, grinding, polishing, painting, heating, lighting, cleaning, gardening, and construction, among other uses. Each of power tools 104, 106, 108, 110, 112, 114, 116, and 118 can be configured to directly communicate with each other (e.g., over a wireless communication channel), and each of power tools 104, 106, 108, 110, 112, 114, 116, and 118 can be configured to communicate directly with wireless communication device 102. In some configurations, each of power tools 104, 106, 108, 110, 112, 114, 116, and 118 can directly communicate with each other according to a wireless protocol, which can be a Bluetooth® wireless protocol. Similarly, each of power tools 104, 106, 108, 110, 112, 114, 116, and 118 can be configured to directly communicate with wireless communication device 102 according to a wireless communication protocol, which can be a Bluetooth® wireless protocol, Wi-Fi wireless protocol, Zigbee wireless protocol, or the like. Power tools 104, 106, 108, 110, 112, 114, 116, and 118 can also be implemented as and/or replaced by systems and devices that may be considered by some as power tool adjacent, such as, for example, jobsite lighting, lasers, and other types of systems and devices.

Power tools 104, 106, 108, 110, 112, 114, 116, and 118 can each include one or more antennas (e.g., as part of one or more Bluetooth® wireless modules) that are capable of communicating with other devices (e.g., other power tools) according to a Bluetooth® wireless protocol, which can have advantages as compared to other wireless protocols (e.g., using less power to communicate, providing fast communication speeds, ensuring one-to-one pairing between devices at some times, etc.). The direct communication range between wireless communication device 102 and a respective power tool 104, 106, 108, 110, 112, 114, 116, or 118 can be fairly short (e.g., 25 or 30 feet), but by using a mesh network, the indirect communication range can be increased considerably as compared to the direct communication range.

Generally, wireless communication device 102 can communicate with server 122 via wireless network 120. More particularly, wireless communication device 102 can communicate with an access point of wireless network 120 to communicate with the server 122 over wireless network 120. The access point can include, for example, a cellular tower or a Wi-Fi router. Additionally, wireless communication device 102 can serve as a gateway device to enable a power tool to communicate with the server 122 via wireless network 140. Server 122 can store data associated with power tools 104, 106, 108, 110, 112, 114, 116, and 118 including configuration data (e.g., operating parameters, current status, network identifiers, etc.), usage data (e.g., number of hours of available operation, number of hours in use, etc.), maintenance data (e.g., maintenance history, suggestions for future maintenance, etc.), operator and ownership data, work site data, location data (e.g., for inventory management and tracking), among other types of data. This data can be viewed from wireless communication device 102 in some examples. Server 122 can be implemented in a variety of manners, such as, for example, an on-premises server or servers, a remote (cloud) server or servers, or a combination of both (hybrid). In some implementations, wireless network 120 is the Internet.

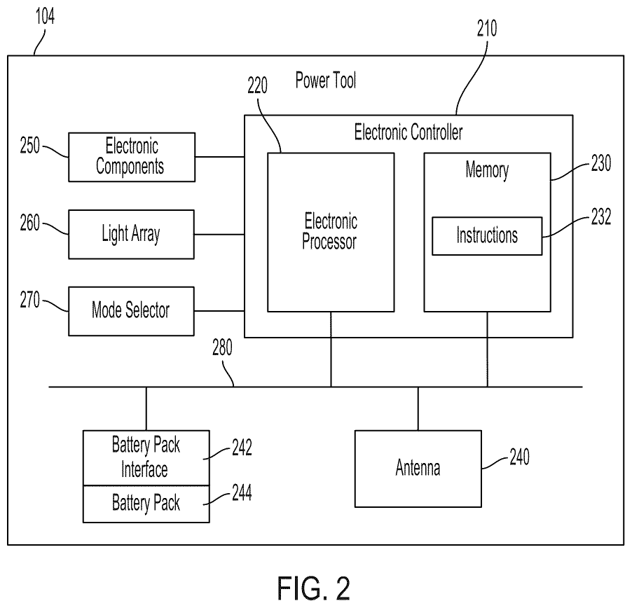

FIG. 2 shows a block diagram illustrating different components of an example implementation of power tool 104. As shown, the example implementation of power tool 104 includes an electronic controller 210, which includes an electronic processor 220 and memory 230. Power tool 104 as shown also includes an antenna 240, a battery pack interface 242, a battery pack 244, a set of electronic components 250, light array 260, a mode selector 270, and a communication bus 280. Memory 230 stores instructions 232 that can be executed by electronic processor 220 such that electronic processor 220 implements operations for power tool 104 in accordance with instructions 232. The operations implemented by electronic processor 220 can include sending and receiving data via communication bus 280 and antenna 240, for example. Power tool 104 can include additional components for communication and other functionality beyond these components illustrated in FIG. 2.

Memory 230 can be implemented using any suitable type or types of memory, including read-only memory (ROM), random access memory (RAM), volatile memory, non-volatile, other non-transitory computer-readable media, and/or various combinations thereof. Data stored in memory 230, including instructions 232, can be generated by wireless communication device 102, server 122, or any of the other power tools 106, 108, 110, 112, 114, 116, and 118 connected to network 120, among other devices. Some of the data stored in memory 230 can be loaded onto power tool 104 at the time of manufacturing, and other data can be stored in memory 230 during the operational lifetime of power tool 104. Electronic processor 220 can be implemented using a variety of different types and/or combinations of processing components and circuitry, including various types of microprocessors, central processing units (CPUs), and the like. In some examples, the memory 230 may store operation modes for the power tool. Each operation mode may be associated with one or more tool settings. For example, each operation mode may include one or more of a mode type (e.g., custom drive control mode, precision torque control mode, mechanical grooved coupling mode), mode name, target torque, light array color, light array brightness, light array light duration, double hit protection enable setting, rotation lock setting, motor rotation speed (e.g., in rotations per minute), or the like.

Antenna 240 can be communicatively coupled to electronic controller 210. Antenna 240 can enable electronic controller 210 (and, thus, the power tool 104) to communicate with other devices, such as, for example, with wireless communication device 102, server 122, and the other power tools 106, 108, 110, 112, 114, 116, and 118 connected to network 120. Antenna 240 can facilitate a communication via Bluetooth® (e.g., in a mesh network), Wi-Fi, and other types of communications protocols. In some examples, antenna 240 can further include a global navigation satellite system (GNSS) receiver of global positioning system (GPS) receives configured to receive signals from satellites, land-based transmitters, and the like to provide location information to electronic controller 210.

Battery pack interface 242 can be configured to selectively receive and interface with battery pack 244 such that battery pack 244 serves as a power source for power tool 104. Battery interface 242 can include one or more power terminals and, in some cases, one or more communication terminals that interface with respective power terminals, communication terminals, etc., of battery pack 244. Battery pack 244 can include one or more battery cells of various chemistries, such as, for example, lithium-ion (Li-Ion), nickel cadmium (Ni-Cad), etc. Battery pack 244 can further selectively latch and unlatch (e.g., with a spring-biased latching mechanism) to the power tool 104 to prevent unintentional detachment. Battery pack 244 can further include a pack electronic controller (pack controller) including a processor and a memory. The pack controller can be configured similarly to electronic controller 210. The pack controller can be configured to regulate charging and discharging of the battery cells, and/or to communicate with the electronic controller 210. Battery pack 244 can further include an antenna, like antenna 240, coupled to the pack controller via a bus like bus 280. Accordingly, battery pack 244 can be configured to communicate with other devices, such as, for example, wireless communication device 102 or the other power tools 106, 108, 110, 112, 114, 116, and 118. Battery pack 244 can communicate battery status information (e.g., percent charged, charging rate, charger connection status, etc.) to electronic controller 210 via battery pack interface 242.

Battery pack 244 can be coupled to and configured to power the various components of the power tool 104, such as, for example, electronic controller 210, the antenna 240, and electronic components 250. However, to simplify the illustration, power line connections between the pack 244 and these components are not illustrated. While the example illustration in FIG. 2 shows power tool 104 being powered by battery pack 244, it is important to note that different types of power sources can be used to power tool 104, and the other power tools 106, 108, 110, 112, 114, 116, and 118 in network 120. For example, power tool 104 could be powered by a wired connection to a power outlet, or other sources of power.

Electronic components 250 can be implemented in a variety of different ways and can include a variety of different components depending on the type of power tool. For example, for a motorized power tool (e.g., drill-driver, saw, etc.), electronic components 250 can include, for example, an inverter bridge, a motor (e.g., brushed or brushless) for driving a tool implement, and the like. For a non-motorized power tool (e.g., a work light, a work radio, ruggedized tracking device, etc.), electronic components 250 can include, for example, one or more of a lighting element (e.g., an LED), an audio element (e.g., a speaker), and the like. In some examples, the antenna 240 can be located within a separate housing along with electronic controller 210 and/or a second electronic controller, where the separate housing selectively attaches to power tool 104. For example, the separate housing can attach to an outside surface of the power tool 104 or can be inserted into a receptacle of power tool 104. Accordingly, the wireless communication capabilities of the power tool 104 can reside in part on a selectively attachable communication device, rather than integrated into a housing of power tool 104 itself. Such selectively attachable communication devices can include electrical terminals that engage with reciprocal electrical terminals of power tool 104 to enable communication between the respective devices and enable power tool 104 to provide power to the selectively attachable communication device. Electronic components 250 can also include different types of sensors, among other suitable components.

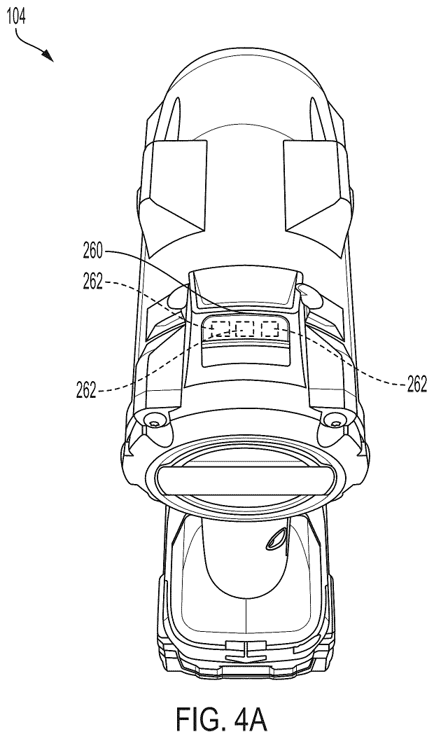

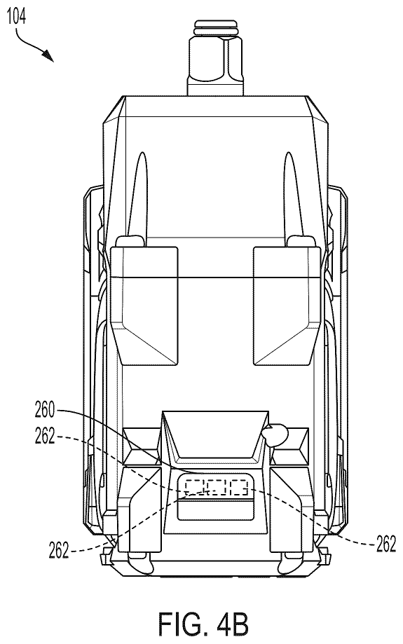

Light array 260 can be implemented in a variety of ways on power tool 104. For example, light array 260 can be positioned in various places on the outer surface of the housing of power tool 104, such as, for example, shown in FIGS. 4A-4B below, among other places. Moreover, light array 260 can be implemented using various types, quantities, and configurations of illuminating elements such as, for example, light-emitting diodes (LEDs). For example, light array 260 can be a 1×3 array of LEDs, a circular ring including a variable number of LEDs, a 3×3 array of LEDs, and other suitable configurations of illuminating elements. Light array 260 can be adapted based on the type of power tool it is included on, for example. Light array 260 can be used to communicate successful tool operations and non-successful tool operations, communicate settings (e.g., setting associated with a selected operational mode) being used on a tool at any given moment in time, to communicate various types of errors and alerts to power tool operators and other personnel, to communicate progress through the duration of tool operations, to communicate whether the tool is currently being operated, and other information associated with power tool operation. Electronic controller 210 can be configured to control operation of light array 260 such that light array 260 displays various lighting patterns and colors to communicate with the operator. In some examples, light array 260 can present errors in different “buckets” associated with error types, such as, for example, presenting yellow colored output light for user errors, green colored light for battery errors, and red colored lights for data transfer issues (e.g., go to app or service center).

Mode selector 270 can likewise be implemented in a variety of ways on power tool 104. For example, mode selector 270 can be implemented as a mode selector switch on the foot of power tool 104, such as, for example, a turntable dial that can be rotated between positions by the operator to select a mode of operation for power tool 104 or a push-button to cycle between the modes of operation. The specific design and positioning of mode selector 270 on a given power tool can vary depending on the type of power tool. For example, mode selector 270 could be positioned on a handle of power tool 104 instead of on a foot of power tool 104, or mode selector 270 could be positioned on a top surface of a housing of power tool 104, among other examples. In certain scenarios, a physical mode selector may not be included on power tool 104, but power tool 104 may instead change between operating modes based on inputs supplied by users via user interface 360, as discussed further below. As the user cycles through operational modes using mode selector 270, electronic controller 210 can display output light via light array 260 in accordance with the selected mode.

Although described with respect to the power tool 104, the diagram of FIG. 2 can also apply to one or more of the other power tools 106, 108, 110, 112, 114, 116, and/or 118 of power tool system 100. The diagram of FIG. 2 can also apply to certain implementations of battery pack 244, except that, in a power tool battery pack implementation, battery pack interface 242 and battery pack 244 of the diagram are replaced with a tool interface (to interface with a battery pack interface of a power tool). In the case of the power tool battery pack implementation, electronic components 250 can include, for example, one or more battery cells, a charge level fuel gauge, analog front ends, different types of sensors, and the like.

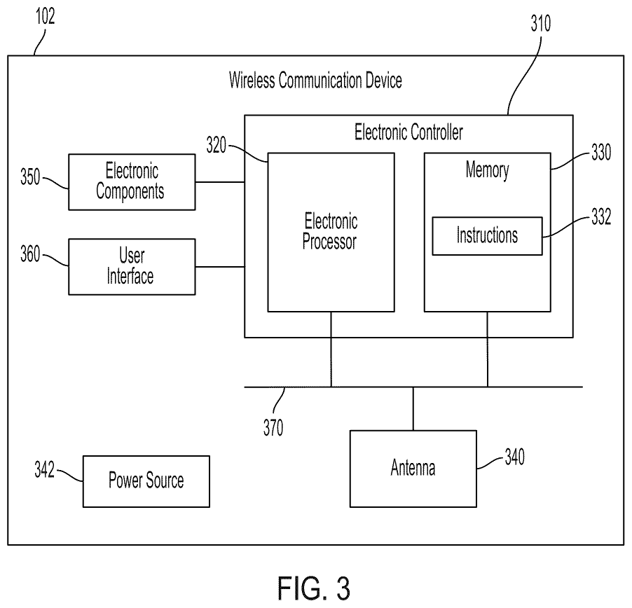

FIG. 3 shows a block diagram illustrating different components of an example implementation of wireless communication device 102. As shown, the example implementation of wireless communication device 102 includes an electronic controller 310, an antenna 340, a power source 342, a set of electronic components 350, a user interface 360, and a communication bus 370. Electronic controller 310 is shown to include an electronic processor 320 and a memory 330, which stores instructions 332 that can be executed by electronic processor 320 such that electronic processor 320 implements operations for wireless communication device 102 in accordance with instructions 332. The operations implemented by electronic processor 320 can include sending and receiving data via antenna 340, for example.

Memory 330 can be implemented using any suitable type or types of memory, including read-only memory (ROM), random access memory (RAM), volatile memory, non-volatile, other non-transitory computer-readable media, and/or various combinations thereof. Data stored in memory 330, including instructions 332, can be generated by wireless communication device 102, server 122, or any of the power tools 104, 106, 108, 110, 112, 114, 116, and 118 connected to network 120, among other devices. Some of the data stored in memory 330 can be loaded onto wireless communication device 102 at the time of manufacturing, and other data can be stored in memory 330 during the operational lifetime of power tool 104. Electronic processor 320 can be implemented using a variety of different types and/or combinations of processing components and circuitry, including various types of microprocessors, central processing units (CPUs), graphics processing units (GPUs), and the like.

Antenna 340 can be implemented using one or more antennas, and can be communicatively coupled to electronic controller 310, for example through communication bus 370. Antenna 340 can enable wireless communication device 102 to communicate with server 122 and the power tools 104, 106, 108, 110, 112, 114, 116, and 118 connected to network 120, among other devices. Power source 342 can be implemented in a variety of ways depending on the type of device (or devices) used to implement wireless communication device 102. For example, power source 342 can be implemented using one or more batteries and/or a wired connection to one or more power outlets.

Electronic components 350 can be implemented in a variety of ways depending on the type of device used to implement wireless communication device 102. For example, in implementations where wireless communication device 102 is a smartphone, electronic components 350 can include a touch screen display, speakers, push buttons, a charging port, and the like. Electronic components 350 can also include different circuitry such as, for example, for lighting, processing, communication (e.g., different types of communication modules including both in hardware and software), charging, and other functionality. Electronic components 350 can also include input devices such as, for example, a keypad, a touch screen, a keyboard, a mouse, and the like.

User interface 360 can be generated and presented on wireless communication device 102 in a variety of ways. For example, user interface 360 can be presented on a display (e.g., a touch screen display) of a smartphone executing a mobile application for controlling and managing power tools. User interface 360 can also be presented on a smartphone display, a computer monitor, a wearable device display, etc. by a web browser processing a web page. User interface 360 can be generated by server 122 and/or wireless communication device 102. Data associated with power tool 104 can be communicated to server 122 and/or wireless communication device 102 and accessed by users via user interface 360. Via user interface 360, power tool operators can perform a variety of different functions, such as, for example, configure various settings for different operational modes of power tool 104, configuring display parameters for light array 260, performing training/calibration of power tool 104 for various tasks, troubleshooting errors (e.g., as indicated by light array 260), and other power tool functions. User interface 360 can include a variety of types of selectable and non-selectable user interface elements, including text boxes, drop down menus, sliders, and other types of user interface elements.

FIG. 4A shows a perspective view of power tool 104 including light array 260. As shown, light array 260 can be formed in an upper portion of the housing of power tool 104. Light array 260 can accordingly be seen on a top surface of power tool 104. Light array 260 can further be positioned behind (rearward) of a trigger of power tool 104. For example, the trigger can be formed in a handle power tool 104 beneath the top surface of power tool 104 and in front of (e.g., closer to the chuck) light array 260. FIG. 4B shows another perspective view of power tool 104 including light array 260. As shown, light array 260 is formed in the upper portion of the housing of power tool 104 such that light array 260 can be seen by an operator of power tool 104 on a top surface of power tool 104. The specific positioning of light array 260 on power tool 104 as shown in FIG. 4A and FIG. 4B can be advantageous in that the positioning allows the operator of power tool 104 to easily see light array 260 when performing an operation (e.g., a drilling operation, etc.) using power tool 104. Moreover, the specific positioning of light array 260 on power tool 104 as shown in FIG. 4A and FIG. 4B can be advantageous in terms of reducing manufacturing complexities and cost associated with power tool 104. In FIGS. 4A-4B, the light array 260 includes an array of three LEDs 262.

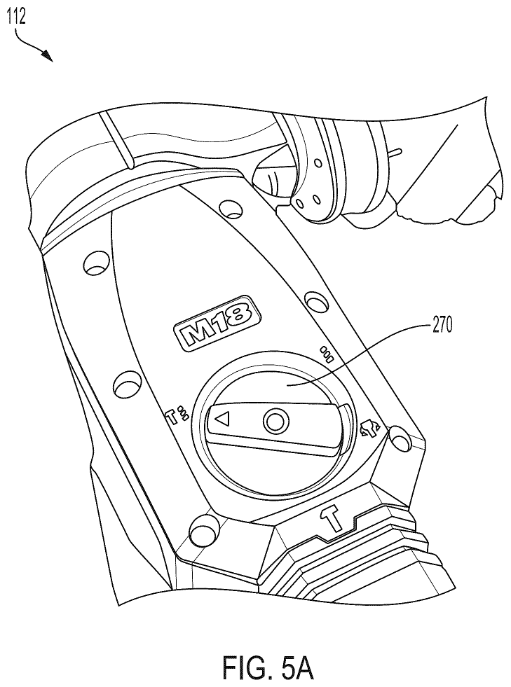

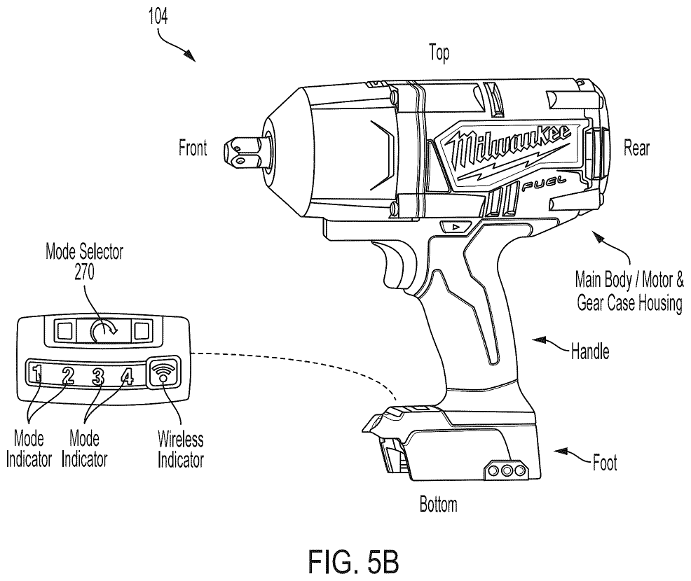

FIG. 5A shows a perspective view of mode selector 270 on power tool 112. As shown, mode selector 270 in this example is implemented as a mode selector switch of power tool 112. More specifically, the mode selector switch is a turntable dial that can be rotated between positions by an operator of power tool 112 to select a mode of operation for power tool 112. Based on the mode selected using mode selector 270, electronic controller 210 can control light array 260 to display a certain color for the duration of a tool operation performed by power tool 112. The color displayed by light array 260 can be configured by the operator of power tool 112 via user interface 360, for example, and can be associated with a particular tool configuration for power tool 112.

FIG. 5B shows a perspective view of mode selector 270 on power tool 104. As shown, mode selector 270 in this example is implemented as a mode selector switch of power tool 104. More specifically, the mode selector switch is a push button that can be depressed by the operator of power tool 104 to cycle power tool 104 between different modes of operation and select a mode of operation for power tool 104. The specific design and positioning of mode selector 270 as shown in FIG. 5B can be advantageous in that it allows the operator of power tool 104 to easily adjust the mode of operation of power tool 104 by accessing the foot of power tool 104. Moreover, the specific design and positioning of mode selector 270 as shown in FIG. 5A and FIG. 5B can be advantageous in terms of reducing manufacturing complexities and cost associated with power tool 104.

FIG. 5B also illustrates general directional references top, bottom, front, and rear as used in this application with respect to power tool 104 and other hand-held power tools having a generally similar layout (e.g., power tools 110, 112, and 114). For example, as used herein, the front generally refers to the output side of the power tool, such as, for example, where the chuck or saw blade retainer is positioned, and the rear generally refers to the opposite side as the front. The top generally refers to side of the power tool having the main body or motor and gear case housing, while the bottom generally refers to the side of the power tool where a battery pack may connect (e.g., the foot of the tool, at the end of the handle). As shown, power tool 104 can further include a mode indicator and a wireless indicator to indicate network connection status and current mode selection for power tool 104.

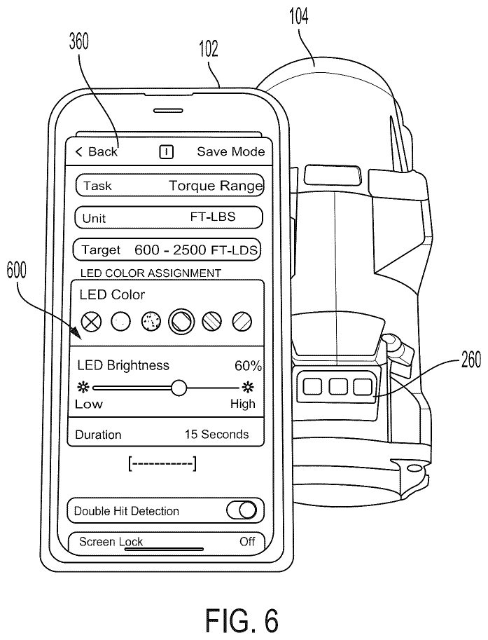

FIG. 6 shows a perspective view of wireless communication device 102 and power tool 104, where an operator of power tool 104 controls light array 260 via user interface 360. As shown in FIG. 6, light array 260 again is formed in the upper portion of the housing of power tool 104 such that light array 260 can be seen by the operator of power tool 104 on a top surface of power tool 104. As shown, via user interface 360, the operator of power tool 104 can configure various settings for different operational modes of power tool 104, which the wireless communication device 102 may then transmit to the power tool 104 for storage on the memory 230 of the power tool 104 (as previously noted with respect to FIG. 2). For example, in FIG. 6, the operator of power tool 104 configures a torque range mode (torque range task) via user interface 360. The operator of power tool 104 can configure various tool operational parameters for a torque range operation performed by power tool 104 when in the torque range mode via user interface 360, including a measurement unit (e.g., foot-pounds) and a target value (e.g., target torque) for the tool operation. The target torque may be a torque threshold whereby, during an operation of the power tool 104 that is implementing a mode with a target torque, the electronic controller 210 may monitor torque and cease driving the motor of the power tool 104 when the target torque is reached. To monitor the torque, the power tool 104 may include a torque sensor, a current sensor, a sensor to detect a number of impacts of the tool, or another sensor, and the electronic controller 210 may detect or infer a torque output by the power tool 104 on a fastener during an operation based on an output from the sensor. The operator of power tool 104 can further configure parameters such as, for example, toggling double hit detection functionality on or off and adjusting directional lock settings via user interface 360. Moreover, the operator of power tool 104 can configure parameters (e.g., select or set values for the parameters) for light array 260 when in the torque range mode via user interface 360, including parameters that control an output color for light array 260 (e.g., white, yellow, orange, pink, light blue, blue, etc.), control a brightness for light array 260, and/or control a duration that the light array is to remain illuminated (e.g., after release of the trigger, after trigger pull, after light array 260 begins to illuminate, after light array 260 begins to illuminate in the selected color, of another start point).

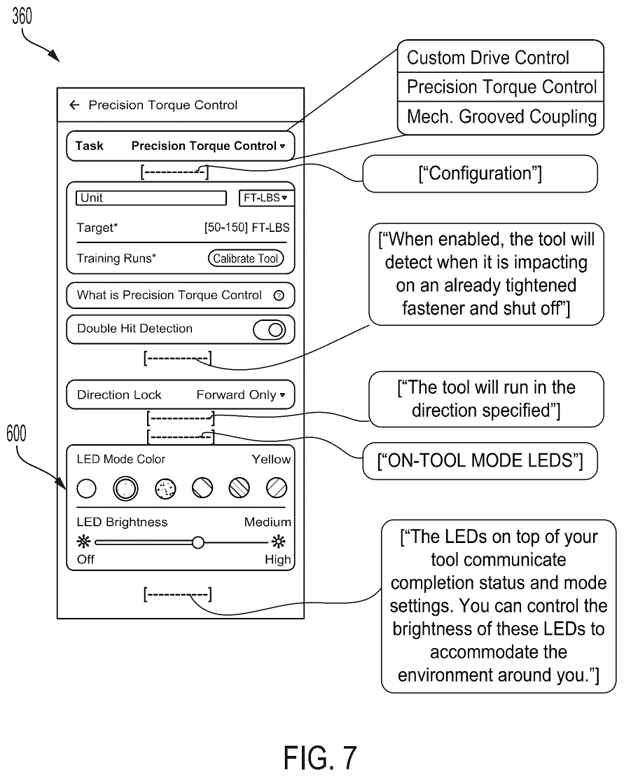

FIG. 7 shows examples of user interface 360 that can be generated and presented on wireless communication device 102 for controlling parameters of power tool 104. As shown, user interface 360 can allow the operator of power tool 104 to configure still further operational parameters for the torque range operation performed by power tool 104 when in the torque range mode. For example, user interface 360 can be used by the operator of power tool 104 to configure various training and/or calibration parameters for power tool 104 and to initiate a training and/or calibration process for power tool 104 for various types of tool operations. Also, user interface 360 can allow the operator of power tool 104 to toggle between different operational modes that are configured for power tool 104 to adjust various parameters associated with the different operations modes.

Further, user interface 360 can allow the operator of power tool 104 to view information about the selected operating mode to help facilitate proper operation of power tool 104 in various operating modes. For example, the operator of power tool 104 can select a selectable user interface element presented on user interface 360 (e.g., “What is Precision torque Control, as shown in FIG. 7) to view additional information regarding the operation of the precision torque control mode. The information can include instructions for how to operate power tool 104 in precision torque control mode and/or how to train/calibrate power tool 104 for the precision torque control mode, for example. After users configure different power tool operational modes (e.g., based on running a series of training runs for a specific type of joint such as, for example, a Victaulic™ coupling or other mechanical grooved coupling), users can share operational modes (e.g., via a library maintained by server 122) such that other users and other power tools can re-use the operational modes without having to go through the same extensive calibration process.

With reference also back to FIG. 2, the power tool 104 may have a plurality of modes stored in the memory 230 of the tool. As noted above, the settings for each operation mode may include, for example, one or more of a mode type (e.g., custom drive control mode, precision torque control mode, mechanical grooved coupling mode), mode name, target torque, light array color, light array brightness, light array light duration, double hit protection enable setting, rotation lock setting, motor rotation speed (e.g., in rotations per minute), or the like. Using input received via the user interface 360, the wireless communication device 102 may obtain values for each of these settings from a user and transmit the settings for each mode to the power tool 104, which is then received by the power tool 104 (e.g., via antenna 240) and stored in the memory 230. In some examples, the user interface 360 displays potential light array colors 600 that a user may select to assign to a particular mode, as shown in FIGS. 6 and 7. During an operation of the tool in the particular mode (e.g., while the trigger is actuated and/or the motor is being driven), the electronic controller 210 may control the light array 260 to output whichever color is selected and assigned as the light array color for that particular mode. The potential light array colors 600 may include a first set of colors, which may be distinct from a second set of colors that the power tool 104 uses to indicate whether a tool operation was successful. For example, the power tool 104 may use red and green (a second set of colors) to indicate whether a tool operation was unsuccessful and successful, respectively, and may use yellow, orange, purple, light blue, and dark blue (a first set of colors) to indicate a particular mode of the power tool 104. Thus, the potential light array colors 600 displayed on the user interface 360 may include a limited set of colors that does not include those colors used to indicate a tool operation was successful or unsuccessful.

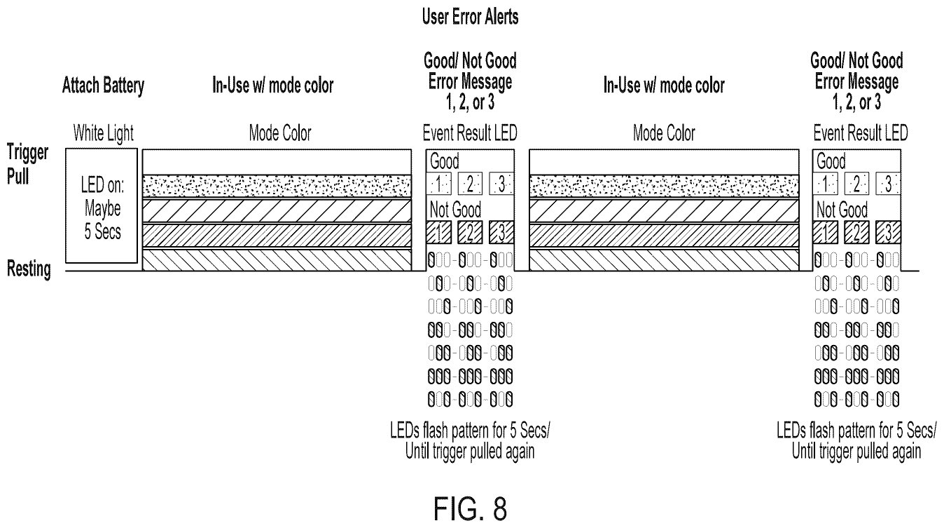

FIG. 8 shows a diagram illustrating example functionality of light array 260 with respect to user error alerts. Generally, the diagram of FIG. 8 is a timing diagram indicating operation of light array 260 and that may be viewed from left to right (time on horizontal (x)-axis), with different examples options for output by light array 260 stacked vertically (on vertical (y)-axis) at a particular moment in time. In the example diagram shown, light array 260 is implemented using three lights (e.g., three LEDs). Electronic controller 210 can control operation of the three LEDs of light array 260 responsive to detecting various parameters associated with power tool 104. When power tool 104 is in a resting state, all three LEDs of light array 260 can be turned off. However, when the trigger of power tool 104 is pulled, or when battery pack 244 is attached to power tool 104, electronic controller 210 can control one or more of the three LEDs of light array 260 such that they output white colored light. When power tool 104 is in use (e.g., when it is performing a tool operation such as, for example, a drive control operation or a precision torque control operation), electronic controller 210 can control one or more of the three LEDs of light array 260 such that they output a particular color of light associated with an operational mode of power tool 104. For example, if an operator of power tool 104 configures a precision torque control mode for power tool 104 via user interface 360, the operator of power tool 104 may set the output light color to yellow when power tool 104 operates in the precision torque control mode. In such an example, electronic controller 210 can control one or more of the three LEDs of light array 260 such that they output yellow light while power tool 104 is operating in the precision torque control mode. Each mode of a plurality of modes of power tool 104 may be associated with a particular (different) color (e.g., as configured via the wireless communication device 102 or at the time of manufacture or firmware update). Accordingly, when operating in a second mode (e.g., a mechanical grooved coupling mode), the electronic controller 210 can control light array 260 to illuminate in a second color that is different from the color associated with the precision torque control mode.

Upon completion of the tool operation or upon detection of an error, electronic controller 210 can control one or more of the three LEDs of light array 260 to blink or flash in accordance with different patterns, as shown in the diagram of FIG. 8. For example, electronic controller 210 can control light array 260 such that light array 260 outputs light in accordance with a particular pattern. For example, electronic controller 210 can control light array 260 such that a first LED (e.g., a left LED) outputs light for one or more time periods, a second LED (e.g., a middle LED) outputs light for one or more time periods, and finally a third LED (e.g., a right LED) outputs light for one or more time periods. The time periods can be different or the same, and the output light can be provided in various different colors depending on the message. For example, the patterns can be presented via green colored output light when the tool operation is successful and via red and/or yellow colored output light when a user error is detected. The diagram shown in FIG. 8 illustrates various example patterns that can be presented via light array 260 to indicate user error alerts. Different patterns can be used to indicate different types of user alerts, depending on the type of tool and/or the type of tool operation being performed. In some examples, the patterns can be presented via light array 260 for a period of 5 seconds, or another suitable time period.

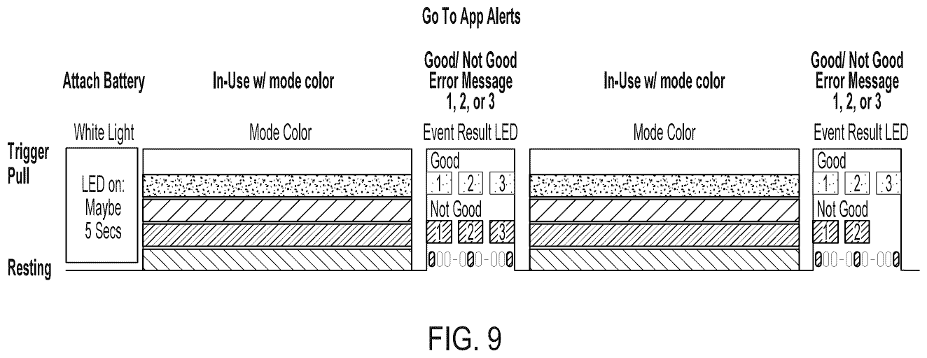

FIG. 9 shows a diagram illustrating example functionality of light array 260 with respect to go to app alerts. Generally, the diagram of FIG. 9 is a timing diagram indicating operation of light array 260 and that may be viewed from left to right (time on horizontal (x)-axis), with different examples options for output by light array 260 stacked vertically (on vertical (y)-axis) at a particular moment in time. In the example diagram shown, light array 260 again is implemented using three lights (e.g., three LEDs). Electronic controller 210 can control operation of the three LEDs of light array 260 responsive to detecting various parameters associated with power tool 104. When power tool 104 is in a resting state, all three LEDs of light array 260 can be turned off. However, when the trigger of power tool 104 is pulled, or when battery pack 244 is attached to power tool 104, electronic controller 210 can control one or more of the three LEDs of light array 260 such that they output white colored light. When power tool 104 is in use (e.g., when it is performing a tool operation such as, for example, a drive control operation or a precision torque control operation), electronic controller 210 can control one or more of the three LEDs of light array 260 such that they output a particular color of light associated with an operational mode of power tool 104.

The diagram shown in FIG. 9 illustrates example functionality of light array 260 when the mode color functionality does not work and the operator of power tool 104 may need to fix or be aware of some kind of issue (e.g., by configuring some kind of setting via user interface 360). For example, the issue can be a mode training/calibration issue, a memory issue (e.g., full memory), and other types of issues. User interface 360 can be presented to the operator of power tool 104 via wireless communication device 102 responsive to execution of a mobile application (e.g., a smartphone “app”) by wireless communication device 102. In such examples, the operator of power tool 104 can be required to launch the mobile application via wireless communication device 102 to receive and view a more detailed explanation of the issue and/or to configure one or more settings associated with power tool 104 via user interface 360. Electronic controller 210 can control light array 260 in such scenarios by displaying the patterns shown in the diagram of FIG. 9. As shown, electronic controller 210 can first cause red colored light to be output by a first LED (e.g., a left LED), then cause red colored light to be output by a second LED (e.g., a middle LED), and finally cause red colored light to be output by a third LED (e.g., a left LED). In some examples, the patterns can be presented via light array 260 for a period of 5 seconds, or another suitable time period.

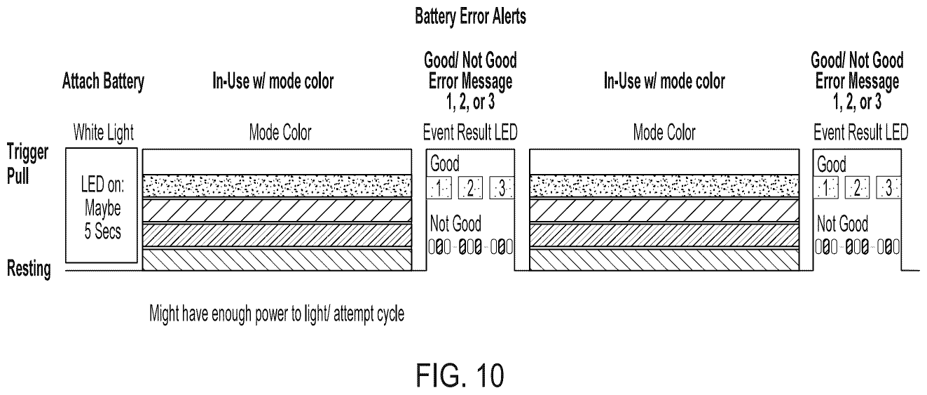

FIG. 10 shows a diagram illustrating example functionality of light array 260 with respect to battery error alerts. Generally, the diagram of FIG. 10 is a timing diagram indicating operation of light array 260 and that may be viewed from left to right (time on horizontal (x)-axis), with different examples options for output by light array 260 stacked vertically (on vertical (y)-axis) at a particular moment in time. In the example diagram shown, light array 260 again is implemented using three lights (e.g., three LEDs). Electronic controller 210 can control operation of the three LEDs of light array 260 responsive to detecting various parameters associated with power tool 104. When power tool 104 is in a resting state, all three LEDs of light array 260 can be turned off. However, when the trigger of power tool 104 is pulled, or when battery pack 244 is attached to power tool 104, electronic controller 210 can control one or more of the three LEDs of light array 260 such that they output white colored light. When power tool 104 is in use (e.g., when it is performing a tool operation such as, for example, a drive control operation or a precision torque control operation), electronic controller 210 can control one or more of the three LEDs of light array 260 such that they output a particular color of light associated with an operational mode of power tool 104.

The diagram shown in FIG. 10 illustrates example functionality of light array 260 when some kind of battery error occurs with power tool 104. For example, battery pack 244 may require charging or replacing before continuing operation of power tool 104. In some scenarios, battery pack 244 may have enough charge to initiate a tool operation and/or initiate mode display functionality via light array 260 but not to finish the tool operation. Electronic controller 210 may detect these scenarios by determining a state of charge of the battery pack 244 (e.g., via a voltage sensor measuring voltage across terminals of the battery, where the voltage indicates or represents the state of charge) and comparing the detected state of charge with a threshold to determine whether the state of charge is above the threshold (sufficient charge) or below the threshold (insufficient charge). Electronic controller 210 can control light array 260 in such scenarios by displaying the patterns shown in the diagram of FIG. 10. As shown, electronic controller 210 can repeatedly and simultaneously cause green colored light to be output by a first LED (e.g., a left LED), cause red colored light to be output by a second LED (e.g., a middle LED), and finally cause green colored light to be output by a third LED (e.g., a left LED). In some examples, the patterns can be presented via light array 260 for a period of 5 seconds, or another suitable time period.

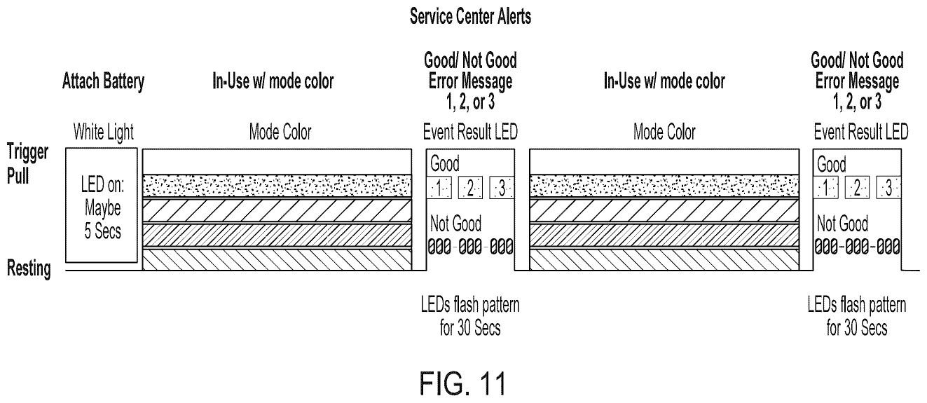

FIG. 11 shows a diagram illustrating example functionality of light array 260 with respect to service center alerts. Generally, the diagram of FIG. 11 is a timing diagram indicating operation of light array 260 and that may be viewed from left to right (time on horizontal (x)-axis), with different examples options for output by light array 260 stacked vertically (on vertical (y)-axis) at a particular moment in time. In the example diagram shown, light array 260 again is implemented using three lights (e.g., three LEDs). Electronic controller 210 can control operation of the three LEDs of light array 260 responsive to detecting various parameters associated with power tool 104. When power tool 104 is in a resting state, all three LEDs of light array 260 can be turned off. However, when the trigger of power tool 104 is pulled, or when battery pack 244 is attached to power tool 104, electronic controller 210 can control one or more of the three LEDs of light array 260 such that they output white colored light. When power tool 104 is in use (e.g., when it is performing a tool operation such as, for example, a drive control operation or a precision torque control operation), electronic controller 210 can control one or more of the three LEDs of light array 260 such that they output a particular color of light associated with an operational mode of power tool 104.

The diagram shown in FIG. 11 illustrates example functionality of light array 260 when a service center issue occurs. For example, electronic controller 210 can detect various types of sensor errors (e.g., loss of communication, outside of expected range, etc.) and data corruption errors. Electronic controller 210 can control light array 260 in such scenarios by displaying the patterns shown in the diagram of FIG. 10. As shown, electronic controller 210 can repeatedly and simultaneously cause red colored light to be output by a first LED (e.g., a left LED), cause red colored light to be output by a second LED (e.g., a middle LED), and cause red colored light to be output by a third LED (e.g., a left LED). In some examples, the patterns can be presented via light array 260 for a period of 5 seconds, or another suitable time period.

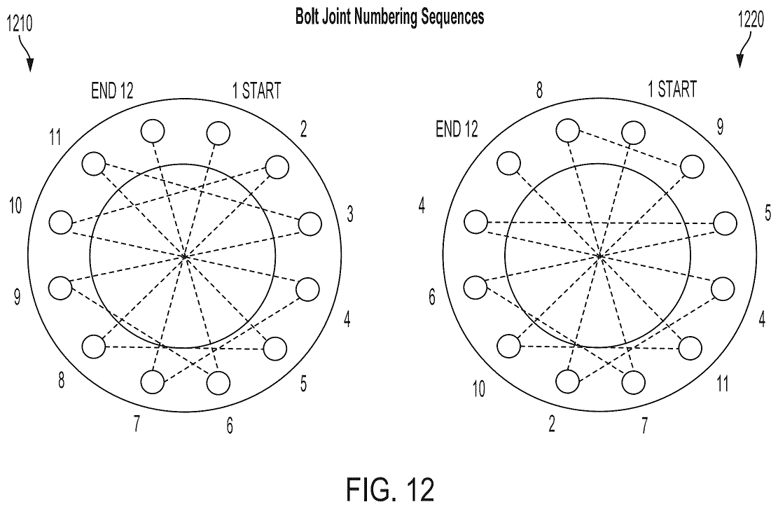

FIG. 12 shows multiple diagrams illustrating example functionality of light array 260 with respect to bolt joint numbering sequences. In this example, light array 260 is ring-shaped with illuminating elements distributed around the ring. A first diagram 1210 shows a legacy bolt joint numbering pattern whereas a second diagram 1220 shows an alternative to the legacy pattern. By controlling the light array 260, for example based on user input provided via user interface 360, legacy bolt numbering patterns can be altered such as, for example, shown in the second diagram 1220. This functionality allows power tool 104 to adjust bolt joint numbering sequences dynamically depending on the application, as opposed to using the same legacy bolt joint numbering sequence for any/all applications. The patterns presented via light array 260 can help guide the operator of power tool 104 through a multi-step fastening process (e.g., for various types of couplings). It will be appreciated that various patterns for indicating bolt joint numbering sequences, as well as indicating other parameters for tasks that can be performed using power tools (e.g., any of power tools 104, 106, 108, 110, 112, 114, 116, and 118), can be implemented and presented to tool operators via light array 260.

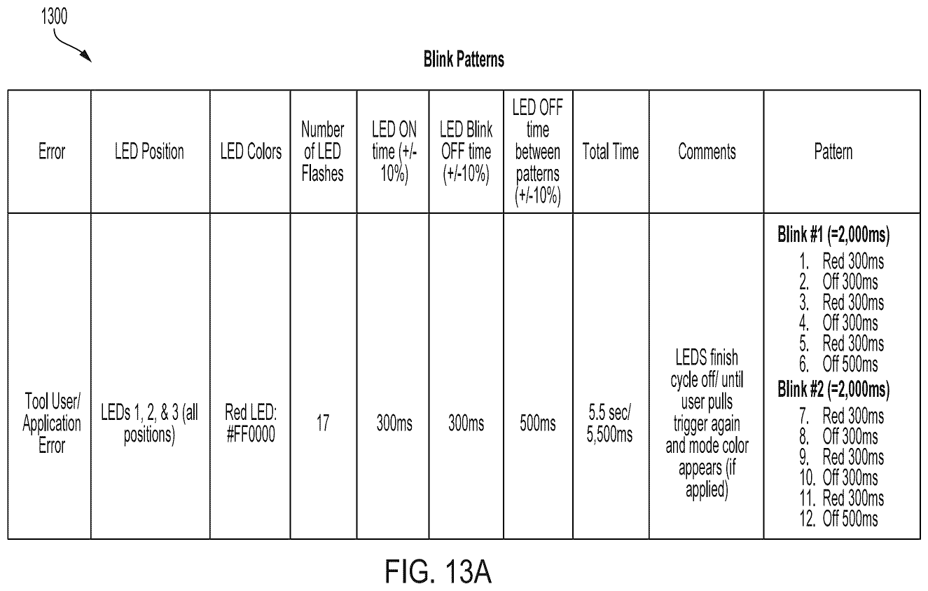

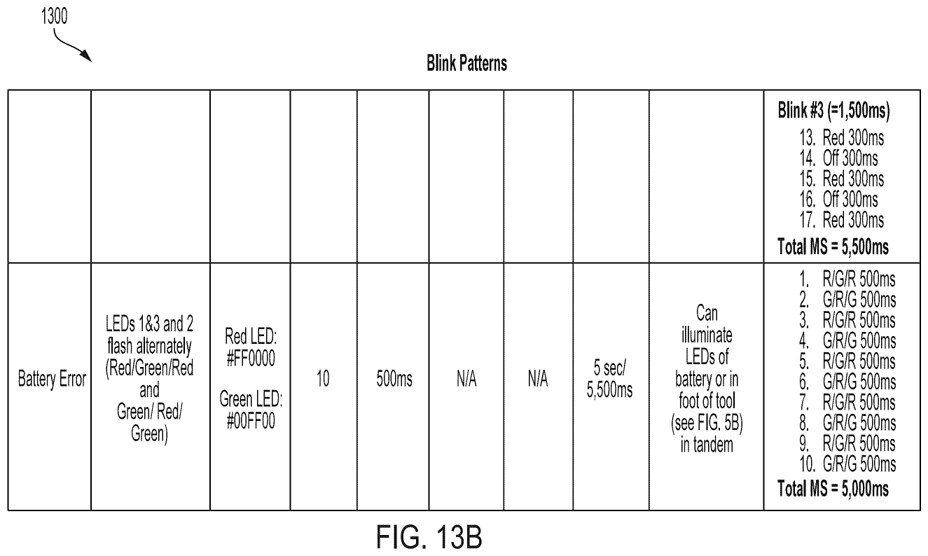

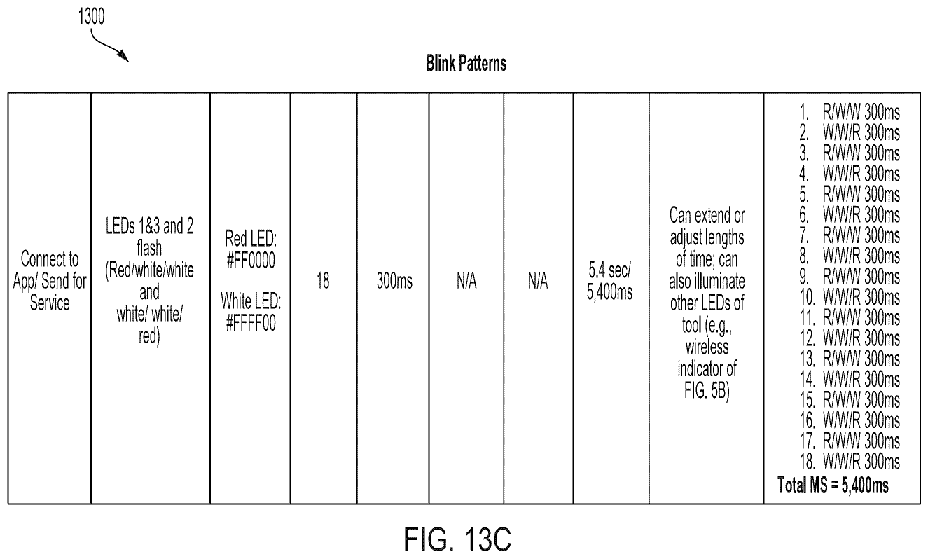

FIGS. 13A-13C show a first table 1300 detailing example blink patterns that can be implemented by light array 260 (e.g., where light array 260 includes three LEDs, as illustrated in FIG. 4A, 4B, or 6). Table 1300 shows a variety of data associated with different types of errors, including user errors, application errors, battery errors, and connection errors. The parameters include LED position, LED colors, number of LED flashes, LED on time (+/−10%), LED blink off time (+/−10%), LED off time between patterns (+/−10%), total time for displaying the pattern, comments about the pattern display, and specific light sequencing for displaying the pattern. It will be appreciated that the example patterns provided in table 1300 are intended to assist the skilled person in understanding the subject matter of the present disclosure, but are not intended to be limiting. In certain scenarios, the particular patterns shown in table 1300 can be advantageous in power tool applications based on user studies and feedback from power tool operators. As such, the particular patterns shown in table 1300 can, in many applications, provide superior alerting functionality to power tool operators for more effective and efficient tool operations.

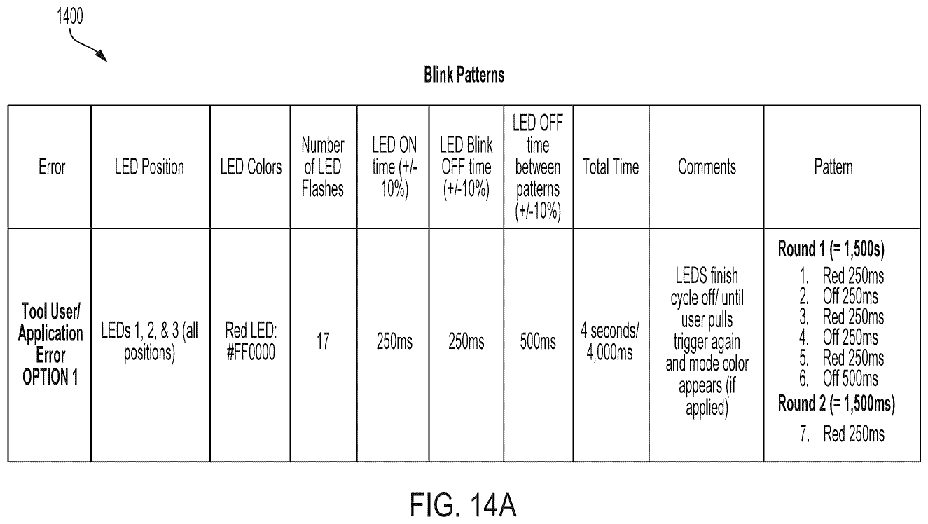

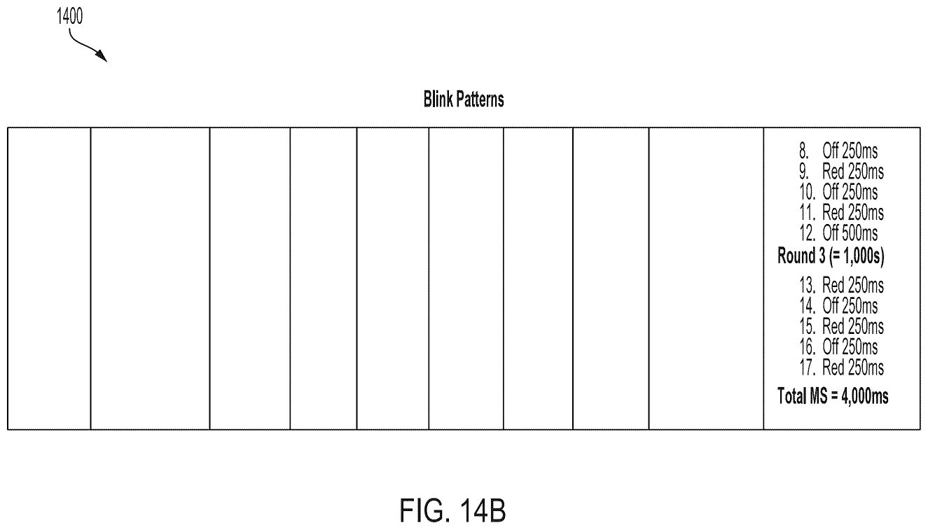

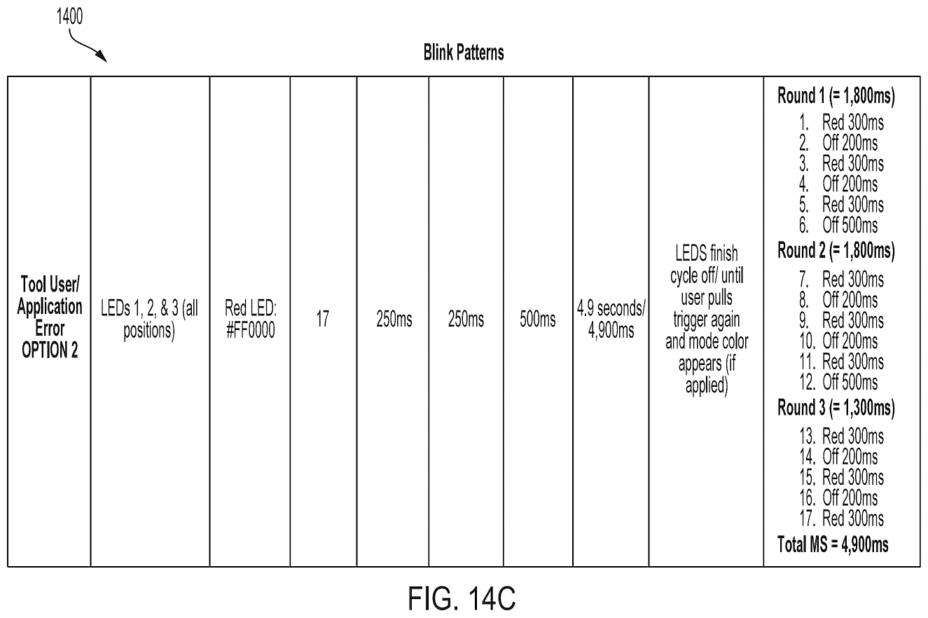

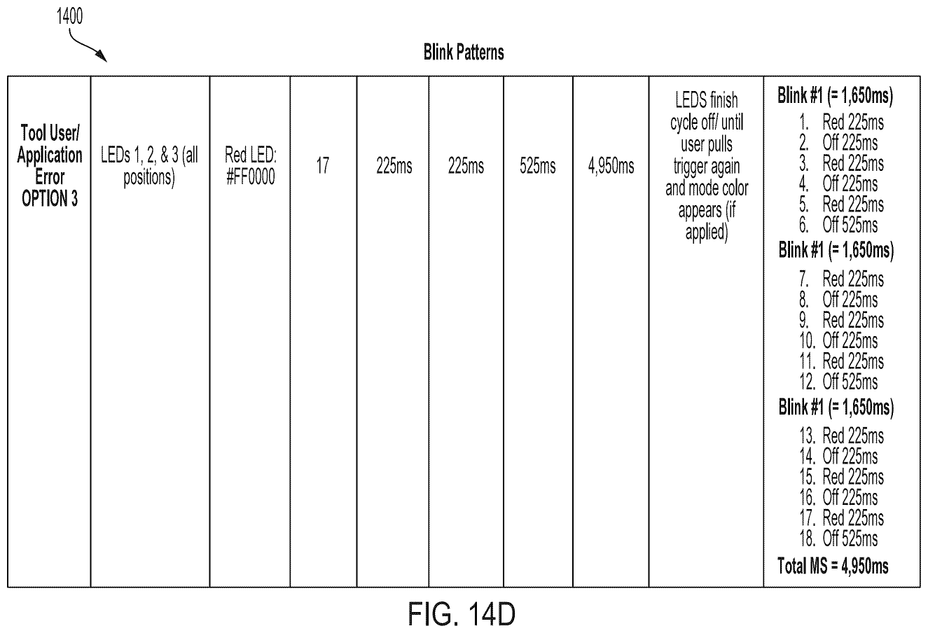

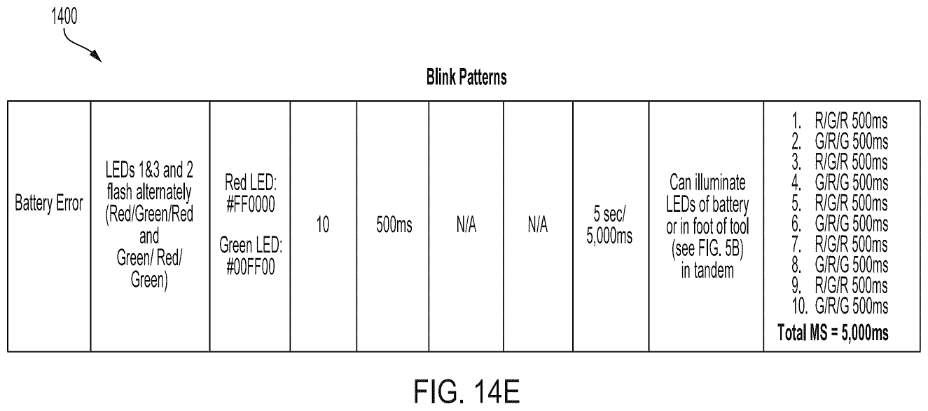

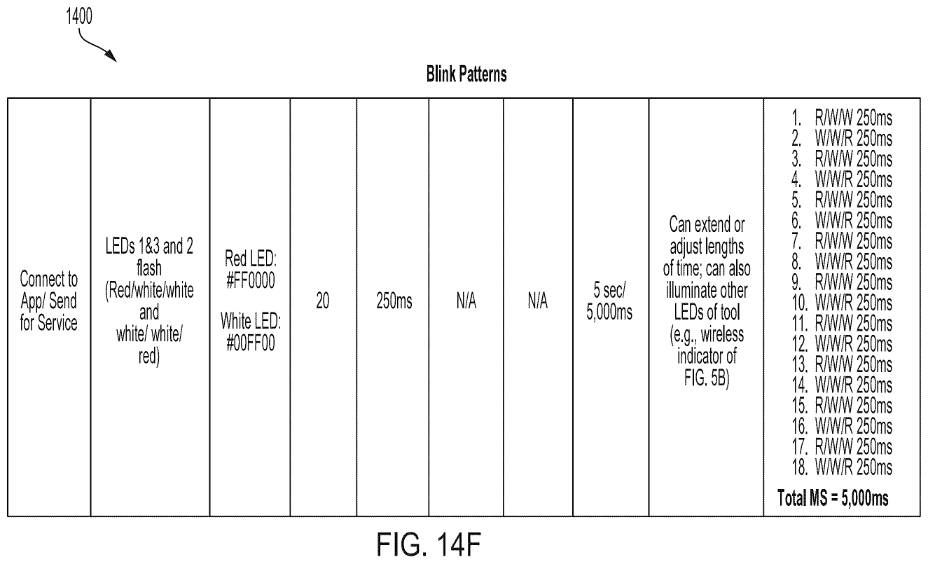

FIGS. 14A-14F show a second table 1400 detailing further example blink patterns that can be implemented by light array 260. Table 1400 again shows a variety of data associated with different types of errors, including user errors, application errors, battery errors, and connection errors. The parameters include LED position, LED colors, number of LED flashes, LED on time (+/−10%), LED blink off time (+/−10%), LED off time between patterns (+/−10%), total time for displaying the pattern, comments about the pattern display, and specific light sequencing for displaying the pattern. It will be appreciated that the example patterns provided in table 1400 are intended to assist the skilled person in understanding the subject matter of the present disclosure, but are not intended to be limiting. In certain scenarios, the particular patterns shown in table 1400 can be advantageous in power tool applications based on user studies and feedback from power tool operators. As such, the particular patterns shown in table 1400 can, in many applications, provide superior alerting functionality to power tool operators for more effective and efficient tool operations.

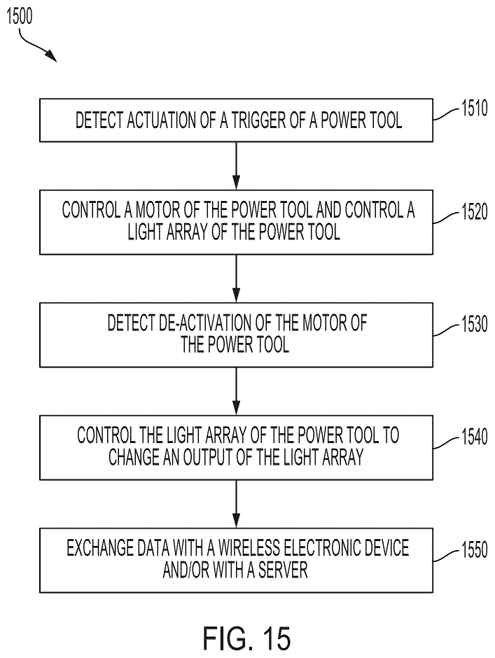

FIG. 15 shows a flowchart illustrating aspects of an example process 1500 for operating power tool 104 and light array 260 during operation of power tool 104. Process 1500 can be performed by various components of power tool 104, including electronic controller 210, antenna 240, electronic components 250, light array 260, and/or mode selector 270, for example. Moreover, process 1500 can be performed in connection with networks and devices external to power tool 104, including wireless communication device 102, network 120, and server 122, for example. Process 1500 can generally be performed by power tool 104 to control operation of light array 260. Accordingly, light array 260 can be used to communicate successful tool operations and non-successful tool operations, communication setting being used on a power tool at any given moment in time, and to communicate various types of errors and alerts to power tool operators and more generally personnel associated with power tools.

At block 1510, electronic controller 210 can detect actuation of a trigger of power tool 104. For example, the operator of power tool 104 can initiate a tool operation (e.g., a drilling operation, a driving operation, a fastening operation, a polishing operating, a cutting operation, etc.) by pulling a trigger of power tool 104. It will be appreciated that in some cases power tools may have alternative actuation mechanisms such that initiating operation of the power tool does not necessarily occur responsive to actuation of a trigger, but rather by another type of actuation mechanism. Electronic controller 210 can detect the actuation of the trigger in a variety of ways, including using various types of sensors and signals that can be processed to determine that actuation of the trigger has occurred. For example, electronic controller 210 may detect activation of the trigger when a voltage output by a trigger sensor rises above a threshold.

At block 1520, electronic controller 210 can control a motor of power tool 104 (e.g., electronic components 250) and also control light array 260 responsive to detecting the actuation of the trigger. Electronic controller 210 can control the motor such that the motor performs in accordance with the intended tool operation. For example, electronic controller 210 can receive a tool configuration including a variety of operational settings for power tool 104, including motor settings, from wireless communication device 102 based on input provided by a user via user interface 360 (e.g., as described above with respect to FIGS. 6-7). Electronic controller 210 can control light array 260 such that light array 260 outputs a first color light indicative of a first mode (e.g., a mode associated with the tool operation) during the duration of the tool operation. For example, as noted above, the tool configuration received from wireless communication device 102 can identify a color for displaying via light array 260 during the duration of the tool operation. Also, different functions may be pre-installed on power tool 104 such that colors for different operations are predetermined and stored on power tool 104. In some examples, electronic controller 210 can change a number of the plurality of illuminating elements of the light array that output the first color light during the duration of the tool operation to indicate completion progress of the tool operation (e.g., a progress bar, etc.).

At block 1530, electronic controller 210 can detect de-activation of the motor. For example, the operator of power tool 104 can complete the tool operation (e.g., a drilling operation, a driving operation, a fastening operation, a polishing operating, a cutting operation, etc.) by releasing a trigger of power tool 104, and the electronic controller 210 may detect de-activation of the motor based on detecting release of the trigger. Again, it will be appreciated that in some cases power tools may have alternative actuation mechanisms such that de-actuation operation of the power tool does not necessarily occur responsive to releasing of a trigger, but rather by another type of de-actuation mechanism. Electronic controller 210 can detect the de-actuation of the trigger in a variety of ways, including using various types of sensors and signals that can be processed to determine that de-actuation of the trigger has occurred. For example, electronic controller 210 may detect deactivation of the trigger when a voltage output by a trigger sensor drops below a threshold. In some examples, the electronic controller 210 detects de-activation of the motor based on an output received from a motor sensor (e.g., a Hall sensor or rotary encoder that indicates motor rotation or position, or a current sensor that indicates motor current) indicative of the motor no longer being driven or rotated. In some examples, the electronic controller 210 detects de-activation of the motor in response to the electronic controller 210 ceasing generation of motor driving control signals (e.g., pulse modulated width (PWM) signals to power switching elements that control current flow to the motor). For example, the electronic controller 210 may monitor torque output by the power tool 104 and, when the torque reaches a predetermined threshold, the electronic controller 210 may cease driving the motor. In response to ceasing driving of the motor, the electronic controller 210 may detect de-activation of the motor (e.g., the electronic controller 210 may infer from the ceasing of the driving of the motor that the motor is de-activated).

At block 1540, electronic controller 210 can control light array 260 to change an output of light array 260 responsive to detecting the de-activation of the motor. Electronic controller 210 can control light array 260 to output a second color light that is different from the first color light and is indicative of whether the tool operation was successful. For example, as discussed above, electronic controller 210 can control light array 260 to output various patterns of green, red, yellow, and other types of light to indicate successful or unsuccessful tool operations, as well as various types of errors associated with operation of power tool 104. Electronic controller 210 can control light array 260 to output the second color light indicative of whether the tool operation was successful until a predetermined period of time elapses (e.g., 5 seconds, 7 seconds, etc.) or until detecting a second actuation of the trigger. The predetermined period of time may be a parameter configured based on user input received via a user interface of the wireless communication device 102 and transmitted by wireless communication device 102 to power tool 104 (e.g., as described with respect to the duration parameter of FIG. 6).

In some examples, to determine whether a tool operation is successful, the electronic controller 210 determines whether a torque target was reached. For example, as previously noted, a mode of the power tool 104 may have a torque target as a setting and may include a sensor to monitor torque output by the power tool 104. During a tool operation, the electronic controller 210 may monitor the torque based on the output of the sensor and, when the torque output by the power tool reaches the torque target, the electronic controller 210 may cease driving the motor of the power tool 104. In such examples, when the torque target is reached, the electronic controller 210 may determine that the tool operation was successful. However, when the electronic controller 210 determines that the tool operation was stopped prematurely, before the torque target was reached, the electronic controller 210 may determine that the tool operation was unsuccessful. The electronic controller 210 may determine that the tool operation was stopped before the torque target was reached when the electronic controller 210 determines, for example, that the trigger or other actuator of the power tool is released or otherwise de-actuated before the torque target was reached, that the motor stopped before the torque target was reached, that an error or fault (e.g., overcurrent or overtemperature condition of the power tool 104) was encountered before the torque target was reached. In other examples, the electronic controller 210 may employ additional or different conditions to determine whether a tool operation was successful or unsuccessful.

At block 1550, power tool 104 can exchange data with wireless communication device 102 and/or server 122. For example, power tool 104 can send a variety of operational data and other types of data to wireless communication device 102 and/or server 122 (e.g., sensor readings, battery status, status of light array 260, mode configurations, etc.). Moreover, power tool 104 can receive inputs from wireless communication device 102 and/or server 122 (e.g., mode configurations, commands, status requests, parameters set via user interface as described with respect to FIGS. 6-7, etc.). Power tool 104 can exchange data with wireless communication device 102 and/or server 122 directly or indirectly (e.g., through a gateway device or another type of networking device or devices). The operation of power tool 104 during process 1500 can be defined at least in part by mode configurations received from wireless communication device 102 and/or server 122 based on user input provided via user interface 360. In some examples, power tool 104 can transmit mode configurations to server 122 such that other power tools (e.g., power tools 106, 108, 110, 112, 114, 116, and 118) can access and use the mode configurations to perform various types of tool operations without requiring manual calibration/training.

Although illustrated serially in a particular order, in some examples, one or more blocks of process 1500 are executed in parallel, partially in parallel, in a different order, or are bypassed. For example, in some examples, block 1550 is bypassed in process 1500. Additionally, in some examples, block 1550 is performed before block 1510 in processor 1500.

In some examples, after block 1540 or 1550, the electronic controller 210 receives a mode selection from a user of the power tool 104 that indicates a second mode that is distinct from the first mode, where the first mode is associated with a first set of settings and the second mode is associated with a second set of settings. The first set of settings may include a first color light for the light array and the second set of settings may include a third color light for the light array, where the third color light is distinct from both the first color light and the second color light. Then, the electronic controller 210 may detect actuation of the trigger of the power tool 104 (similar to as described with respect to block 1510) to begin a second operation, control the motor of the power tool 104 according to the second mode and control the light array of the power tool to emit the third color light (similar to as described with respect to block 1520), detect deactivation of the motor of the power tool (similar to as described with respect to block 1530), and control the light array of the power tool 104 to change an output of the light array 260 responsive to detecting the de-activation of the motor (similar to as described with respect to block 1540, e.g. to indicate whether the too operation was successful). When changing the output of the light array 260 responsive to detecting the de-activation of the motor for this second operation, the color output of the light array 260 may be the second color (e.g., if the second operation had a similar successful or unsuccessful outcome as the initial operation) or may be a fourth color that is distinct from the first, second, and third colors (e.g., if the second operation had an opposite successful or unsuccessful outcome as the initial operation).

Thus, in some examples, the electronic controller 210 may receive a first mode selection from a user of the power tool 104 via the mode selector 270 and, based on the first mode selection, select the first color light indicative of the first mode for output by the light array in response to detecting actuation of the trigger. Then, the electronic controller 210 may receive a second mode selection from a user of the power tool via the mode selector 270 and, based on the second mode selection, select the third color light indicative of the second mode for output by the light array for a duration of a second tool operation in response to detecting a second actuation of the trigger.

As described with respect to FIGS. 6 and 7, the first and third color lights may be selected via a user interface 360 and transmitted to the power tool 104 as part of the first set and second set of settings for the first and second modes. Further, as discussed above with respect to FIGS. 6 and 7, the first and third color lights may be selected from a first set of potential colors used for indicating modes of the power tool (see, e.g., potential light array colors 600 of FIGS. 6-7) and the second color light may be selected from a second set of colors used to indicate whether an operation is successful or not successful. Additionally, the first and second modes may each be or include a forward driving mode of the power tool 104. A forward driving mode may be a mode that includes driving the motor of the power tool 104 to provide a clockwise torque to drive a fastener or tighten a nut or bolt. In some examples, the first and second modes may each have a distinct torque target. Accordingly, when the power tool 104 is being operated, the power tool 104 may indicate, and a user and other individuals in the vicinity of the power tool 104 may observe, whether the power tool 104 is operating in the first mode with a first torque target when the light array emits the first color light, or is operating in the second mode with the second torque target when the light array emits the second color light. In some examples, the power tool 104 may store and be operable in more than two modes, each with a respective light array color and torque target, among other mode settings set via the user interface 360, as previously described.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising”, or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top”, “front”, or “back” features is generally intended as a description only of the orientation of such features relative to a reference frame of a particular example or illustration. Correspondingly, for example, a “top” feature can sometimes be disposed below a “bottom” feature (e.g., when a tool is physically rotated) and so on, in some arrangements or aspects. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as, for example, an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components can be consolidated and performed by a single component. Similarly, the functions described herein as being performed by one component can be performed by multiple components in a distributed manner. Additionally, a component described as performing particular functionality can also perform additional functionality not described herein. For example, a device or structure that is “configured” in a certain way is configured in at least that way, but can also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as, for example, those used in transmitting and receiving electronic mail or in accessing a network such as, for example, the Internet or a local area network (LAN). Those skilled in the art will recognize that many modifications can be made to these configurations without departing from the scope or spirit of the claimed subject matter.

Certain operations of methods according to the disclosure, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” etc. are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as, for example, “first”, “second”, etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions can be used to discuss aspects of a particular example or figure, but do not necessarily require similar orientation or geometry in all installations or configurations.

As used herein, unless otherwise defined or limited, the phase “and/or” used with two or more items is intended to cover the items individually and both items together. For example, a device having “a and/or b” is intended to cover: a device having a (but not b); a device having b (but not a); and a device having both a and b.

The discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A power tool, comprising:
a housing;
a motor supported by the housing;
a trigger assembly supported by the housing, the trigger assembly comprising a trigger that is configured to be actuated;
a light array supported by the housing and comprising a plurality of illuminating elements configured to output light in a plurality of colors; and
an electronic controller comprising a processor and a memory, the electronic controller coupled to the motor, the trigger assembly, and the light array, and configured to:
detect actuation of the trigger;
in response to detecting actuation of the trigger, control the motor to perform a tool operation according to a first mode of a plurality of tool modes of the power tool and control the light array to output a first color light indicative of the first mode for a duration of the tool operation;
detect de-activation of the motor; and
in response to detecting de-activation of the motor, control the light array to output a second color light that is different from the first color light and indicative of whether the tool operation was successful.

2. The power tool of claim 1, wherein the light array supported by the housing is positioned on a top surface of the housing such that the light array is located behind the trigger.

3. The power tool of claim 1, wherein the electronic controller is configured to:
control the light array to output the second color light responsive to determining that the tool operation was successful; and
control the light array to output a third color light that is different from the first color light and different from the second color light responsive to determining that the tool operation was not successful.

4. The power tool of claim 3, wherein the electronic controller is configured to control the light array to output a fourth color light responsive to detecting a connection of a battery to the power tool.

5. The power tool of claim 3, wherein the electronic controller is configured to control the light array to output a pattern using the third color light, the pattern indicative of an error type associated with the tool operation.

6. The power tool of claim 1, wherein the electronic controller is configured to change a number of the plurality of illuminating elements of the light array that output the first color light during the duration of the tool operation to indicate completion progress of the tool operation.

7. The power tool of claim 1, wherein the electronic controller is configured to control the light array to output the second color light indicative of whether the tool operation was successful until a predetermined period of time elapses or until detecting a second actuation of the trigger.

8. The power tool of claim 1, wherein the electronic controller is configured to
receive a first mode selection from a user of the power tool that selects the first mode;
based on the first mode selection, select the first color light indicative of the first mode for output by the light array in response to detecting actuation of the trigger;
receive a second mode selection from a user of the power tool that selects a second mode; and
based on the second mode selection, select a third color light indicative of the second mode for output by the light array for a duration of a second tool operation in response to detecting a second actuation of the trigger, wherein the third color light is distinct from the first color light and the second color light.

9. The power tool of claim 8, wherein the first mode is defined by first mode settings including the first color light and a first torque target and the second mode is defined by second mode settings including the third color light and a second torque target.

10. The power tool of claim 1, wherein the electronic controller is configured to receive a mode configuration from a user device, the mode configuration comprising settings for the power tool when operating in the first mode, the settings comprising the first color light indicative of the first mode.

11. The power tool of claim 10, wherein the electronic controller is configured to receive the mode configuration from the user device based on input provided by a user via a user interface presented on the user device.

12. The power tool of claim 10, wherein the electronic controller is configured transmit the mode configuration to an external server such that a second power tool can access and use the mode configuration to perform the tool operation.

13. A method performed by a power tool, comprising:
detecting actuator of a trigger of the power tool;
in response to detecting actuation of the trigger, control a motor of the power tool to perform a tool operation according to a first mode of a plurality of tool modes of the power tool and control a light array of the power tool to output a first color light indicative of the first mode for a duration of the tool operation;
detecting de-activation of the motor of the power tool; and
controlling the light array of the power tool to output a second color light that is different than the first color light and indicative of whether the tool operation was successful.

14. The method of claim 13, comprising:
controlling the light array to output the second color light responsive to determining that the tool operation was successful;
controlling the light array to output a third color light that is different from the first color light and different from the second color light responsive to determining that the tool operation was not successful; and
controlling the light array to output a pattern using the third color light, wherein the pattern is indicative of an error type associated with the tool operation.

15. The method of claim 13, comprising controlling the light array to output a fourth color light responsive to detecting a connection of a battery to the power tool.

16. The method of claim 13, comprising changing a number of a plurality of illuminating elements of the light array that output the first color light during the duration of the tool operation to indicate completion progress of the tool operation.

17. The method of claim 13, comprising controlling the light array to output the second color light indicative of whether the tool operation was successful until a predetermined period of time elapses or until detecting a second actuation of the trigger.

18. The method of claim 13, comprising
receiving a first mode selection from a user of the power tool that selects the first mode;
based on the first mode selection, selecting the first color light indicative of the first mode for output by the light array in response to detecting actuation of the trigger;
receiving a second mode selection from a user of the power tool that selects a second mode;
based on the second mode selection, select a third color light indicative of the second mode for output by the light array for a duration of a second tool operation in response to detecting a second actuation of the trigger, wherein the third color light is distinct from the first color light and the second color light.

19. The method of claim 13, comprising receiving a mode configuration from a user device, the mode configuration comprising settings for the power tool when operating in the first mode, the settings including the first color light and a first torque target.

20. The method of claim 19, comprising receiving the mode configuration from the user device based on input provided by a user via a user interface presented on the user device.
